(19) United States
(12) Patent Application Publication
(10) Pub. No.: US 2025/0346279 A1
(43) Pub. Date: Nov. 13, 2025

(54) YOKE TYPE STEERING HANDLE FOR VEHICLE

(71) Applicant: GM Global Technology Operations LLC, Detroit, MI (US)

(72) Inventors: Minseok Jeon, Gimpo-si (KR); Jihun Kim, Bupyeong-gu (KR); Euikeun Song, Seongdong-gu (KR); Kwangmin Park, Seoul (KR)

(21) Appl. No.: 18/659,627

(22) Filed: May 9, 2024

(51) Int. Cl. B62D 1/04; B62D 3/02

(52) U.S. Cl. CPC B62D 1/04; B62D 1/06; B62D 1/16; B62D 3/02

(57) ABSTRACT

A steering assembly of a vehicle includes a housing configured for operable connection to a steering column of the vehicle, and one or more steering handles located at the housing. The one or more steering handles are rotatably mounted to the housing to rotate about respective steering handle axes relative to the housing between an extended position and a folded position.

### INTRODUCTION

The subject disclosure relates to vehicles, and more particularly to steering systems for vehicles.

A traditional steering system for a vehicle includes a steering wheel that is fixed in size and position in the passenger compartment of the vehicle. In highly automated vehicles, however, such as level 4 (LV4) or automated electric vehicles (AEVs), needs for the vehicle driver to utilize the steering system are different from those needs in a traditional vehicle. This allows for the potential to improve interior space utilization in the passenger compartment by modifying the steering system.

### SUMMARY

In one exemplary embodiment, a steering assembly of a vehicle includes a housing configured for operable connection to a steering column of the vehicle, and one or more steering handles located at the housing. The one or more steering handles are rotatably mounted to the housing to rotate about respective steering handle axes relative to the housing between an extended position and a folded position.

In addition to one or more of the features described herein the one or more steering handles is two steering handles positioned at opposing lateral sides of the housing. The steering assembly further includes two spur gears. Each steering handle of the two steering handles is operably connected to a respective spur gear of the two spur gears. The two spur gears are meshed with each other inside the housing. Rotation of the two spur gears rotates the two steering handles about their respective steering handle axes.

In addition to one or more of the features described herein a motor is operably connected to at least one spur gear of the two spur gears to drive rotation of the two spur gears.

In addition to one or more of the features described herein a housing opening in the housing receives a steering column of the vehicle. The steering assembly is configured to rotate about a steering column axis together with the steering column.

In addition to one or more of the features described herein the steering assembly is configured to selectably translate along the steering column axis relative to the steering column.

In addition to one or more of the features described herein one or more alignment grooves are positioned in the housing opening to rotationally align the steering assembly with the steering column.

In addition to one or more of the features described herein an air bag module is positioned in the housing.

In another exemplary embodiment, a steering system of a vehicle includes a steering column, and a steering assembly operably connected to and rotatable about a steering column axis with the steering column. The steering assembly includes a housing configured for operable connection to the steering column, and two steering handles positioned at opposing lateral sides of the housing. The two steering handles are rotatably mounted to the housing to rotate about respective steering handle axes relative to the housing between an extended position and a folded position.

In addition to one or more of the features described herein the steering assembly includes two spur gears. Each steering handle of the two steering handles is operably connected to a respective spur gear of the two spur gears. The two spur gears are meshed with each other inside the housing. Rotation of the two spur gears rotates the two steering handles about their respective steering handle axes.

In addition to one or more of the features described herein a motor is operably connected to at least one spur gear of the two spur gears to drive rotation of the two spur gears.

In addition to one or more of the features described herein a housing opening in the housing receives the steering column.

In addition to one or more of the features described herein the steering assembly is configured to selectably translate along the steering column axis relative to the steering column.

In addition to one or more of the features described herein one or more alignment grooves are positioned in the housing opening to rotationally align the steering assembly with the steering column.

In addition to one or more of the features described herein an air bag module is positioned in the housing.

In yet another a vehicle includes a vehicle body defining a passenger compartment, and a steering system of the vehicle positioned in the passenger compartment. The steering system includes a steering column, and a steering assembly operably connected to a rotatable about a steering column axis with the steering column. The steering assembly includes a housing configured for operable connection to the steering column, and two steering handles positioned at opposing lateral sides of the housing. The two steering handles are rotatably mounted to the housing to rotate about respective steering handle axes relative to the housing between an extended position and a folded position.

In addition to one or more of the features described herein the steering assembly includes two spur gears. Each steering handle of the two steering handles is operably connected to a respective spur gear of the two spur gears. The two spur gears are meshed with each other inside the housing. Rotation of the two spur gears rotates the two steering handles about their respective steering handle axes.

In addition to one or more of the features described herein a housing opening is positioned in the housing to receive the steering column.

In addition to one or more of the features described herein the steering assembly is configured to selectably translate along the steering column axis relative to the steering column.

In addition to one or more of the features described herein one or more alignment grooves are positioned in the housing opening to rotationally align the steering assembly with the steering column.

In addition to one or more of the features described herein an instrument panel is positioned in the passenger compartment, and the steering column extends from a steering opening in the instrument panel. The steering handle is selectably translatable at least partially into the steering opening.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an embodiment of a vehicle;

FIG. 2 is a partial perspective view of an embodiment of an instrument panel and steering column of a vehicle;

FIG. 3 is a partially disassembled view of an embodiment of a steering handle of a vehicle;

FIG. 4. is a partial perspective view of an embodiment of a steering handle in a normal driving position;

FIG. 5 is a partial perspective view of an embodiment of a steering handle in a retracted position;

FIG. 6 is another partial perspective view of an embodiment of a steering handle in a retracted position;

FIG. 7 is a partial perspective view of an embodiment of a housing interface to a steering column;

FIG. 8 illustrates an embodiment of a steering handle in a normal driving position;

FIG. 9 is another illustration of an embodiment of a steering handle in a normal driving position; and

FIG. 10 is an illustration of an embodiment of a steering handle in a retracted position.

### DETAILED DESCRIPTION

The following description is merely exemplary in nature and is not intended to limit the present disclosure, its application or uses. It should be understood that throughout the drawings, corresponding reference numerals indicate like or corresponding parts and features.

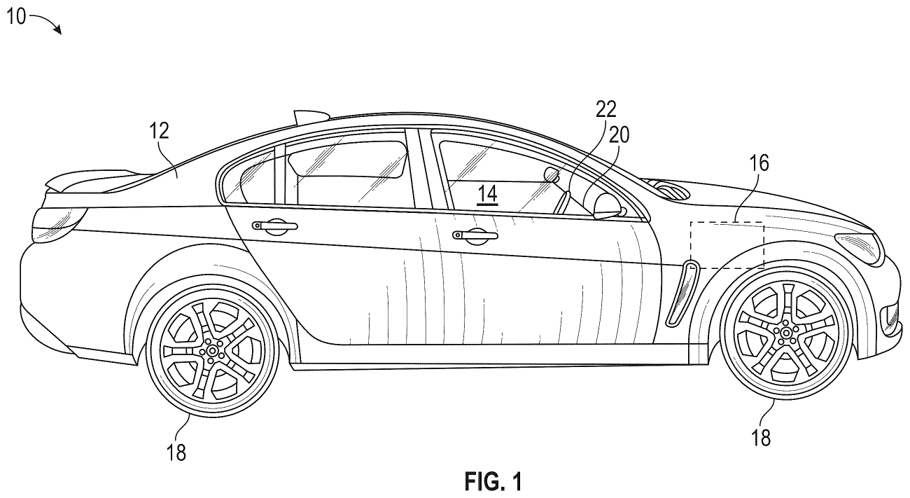

In accordance with an exemplary embodiment, illustrated in FIG. 1 is an embodiment of a vehicle 10. The vehicle 10 includes a vehicle body 12 defining a passenger compartment 14. The vehicle 10 further includes a powertrain 16 providing energy for propulsion and electrical power for operation of the vehicle systems. A plurality of wheels 18 are operably connected to the powertrain 16, and at least two of the wheels 18 are steerable. An instrument panel 20 is located in the passenger compartment 14, and a steering assembly 22 extends from the instrument panel 20 into the passenger compartment 14.

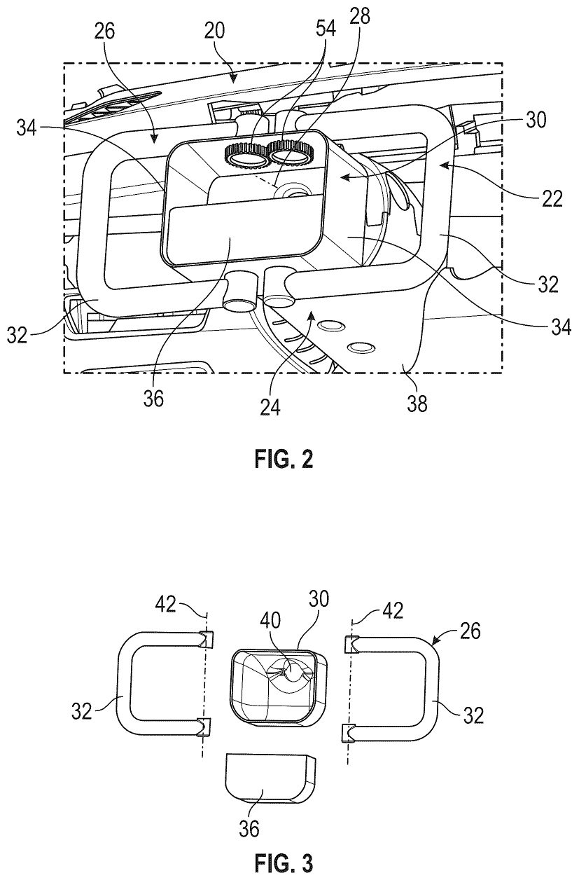

Referring now to FIG. 2, an embodiment of the instrument panel 20 is illustrated together with the steering assembly 22. The steering assembly 22 includes a steering column 24 with a steering handle 26 operably connected thereto. In some embodiments, a steering column trim 38 is installed at least partially covering the steering column 24. Rotation of the steering column 24 about a column axis 28 via the steering handle 26 turns the wheels 18 to steer the vehicle 10. The steering handle 26 includes a housing 30 and steering frames 32 extending from each lateral side 34 of the housing 30. As illustrated in the partially disassembled view of FIG. 3, the steering handle 26 further includes an air bag module 36 disposed in the housing 30. The housing 30 includes a housing opening 40 through which the steering handle 26 is operably connected to the steering column 24. The steering handle 26 is operably connected to the steering column 24 such that the steering column 24 is rotationally locked to the steering handle 26 to rotate therewith.

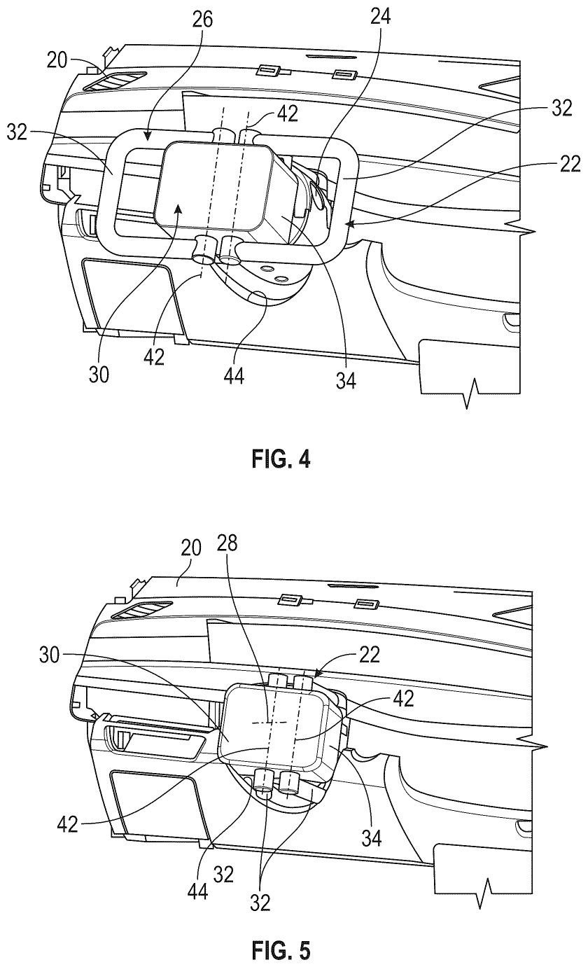

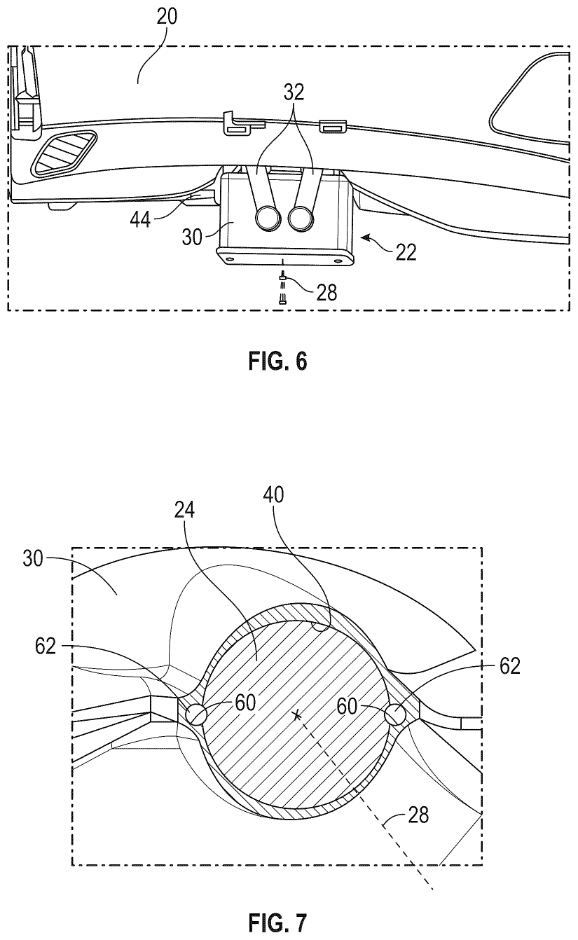

The steering assembly 22 is movable between a normal driving position as illustrated in FIG. 4 and a stowed or retracted position as illustrated in FIG. 5. To move from the normal driving position to the retracted position, the steering frames 32 are rotated about respective steering frame axes 42 to fold the steering frames 32 towards the lateral sides 34 of the housing 30. Additionally, as best shown in FIG. 6, once the steering frames 32 are folded, the steering assembly 22 may be moved along the column axis 28 by moving the steering assembly 22 along the steering column 24 to retract it into a steering opening 44 of the instrument panel 20. Referring now to FIG. 7, one or more housing grooves 60 are defined in the housing 30 at the housing opening 40. Complimentary column features 62 of the steering column 24 are received in the housing grooves 60 to maintain rotational alignment of the steering handle 26 relative to the steering column 24, and to maintain this alignment when the steering handle 26 is moved relative to the steering column 24 along the column axis 28.

In the retracted position, the folded steering frames 32 may be at least partially recessed into the instrument panel 20 at the steering opening 44, as also illustrated in FIG. 6. Retraction of the steering assembly 22 improves flexibility of and available space of the passenger compartment 14 when use of the steering assembly 22 is not needed.

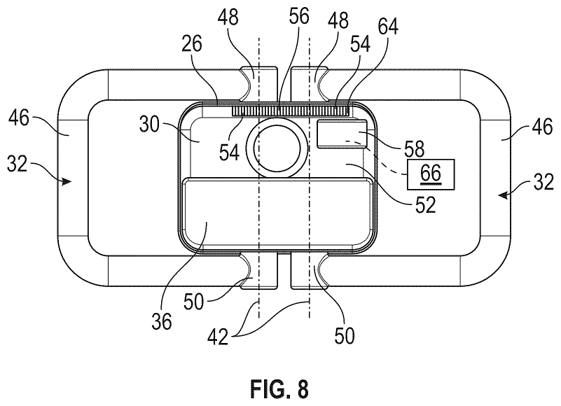

Referring now to FIGS. 8-10, the folding of the steering frames 32 will be described in greater detail. The steering frames 32 each have a frame body 46 extending between a first frame end 48 and a second frame end 50. In some embodiments, the frame bodies 46 are substantially C-shaped, but one skilled in the art will readily appreciate that this shape is merely exemplary and that other shapes of the steering frames 32 are contemplated within the scope of the present disclosure.

At least a portion of the frame bodies 46 of the steering frames 32 extend into an interior 52 of the housing 30. The first frame ends 48 are operably connected to spur gears 54. The spur gears 54 are meshed together at a mesh location 56 between the steering frame axes 42. In some embodiments, the spur gears 54 are positioned coaxially with the steering frame axes 42. The spur gears 54 are meshed together such that when one steering frame 32 is urged to rotate about its steering frame axis 42, the other steering frame 32 is likewise urged to rotate about its respective frame axis 42.

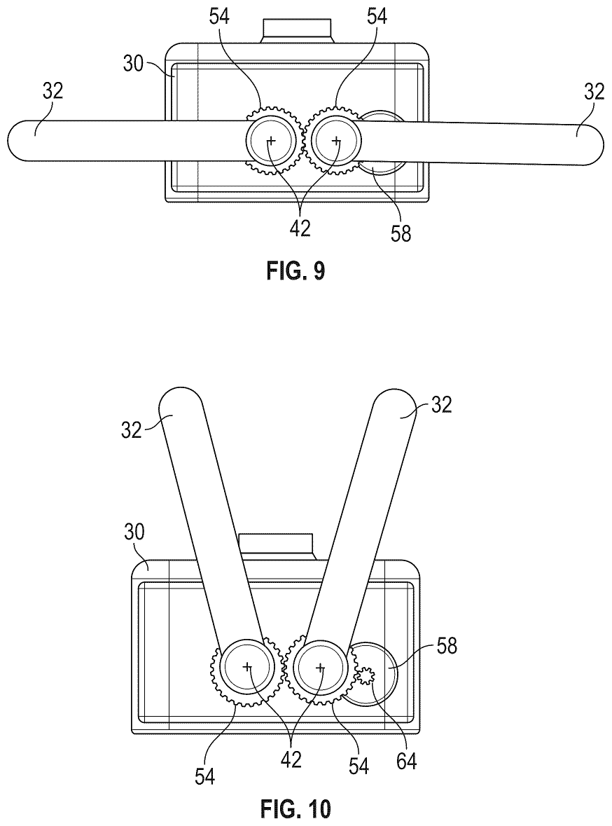

In some embodiments, the fold operation of the steering frames 32 is powered. For example, in the illustrated embodiments an electric motor 58 is disposed in the housing 30 and is connected to one or more of the spur gears 54 via a motor gear 64. When the electric motor 58 is operated via, for example, operation of a motor switch 66 connected to the electric motor 58, rotation of the motor gear 64 drives rotation of the spur gears 54 and their respective steering frames 32 between the normal operating position such as illustrated in FIG. 9 and the folded position such as illustrated in FIG. 10. One skilled in the art will appreciate that his arrangement of the electric motor 58 is merely exemplary. In other embodiments, for example, the electric motor 58 may directly drive the spur gears 54, without the connection via the motor gear.

By allowing the steering handle 26 to fold towards the instrument panel 20 and to telescope when folded, the presently disclosed configurations significantly reduce the size of the steering handle 26, creating more space within the passenger compartment 14. This is particularly advantageous in parking situations where space is limited. The folding and telescoping functions offer added convenience to the driver, allowing the driver to adjust the steering handle 26 according to their preferences and comfort. The housing 30 ensures that safety features, such as the air bag module 36 are integrated seamlessly into the steering handle 26 maintaining the vehicle's safety standards. The incorporation of electrical components for automatic movements aligns the steering system with modern automotive trends, enhancing the vehicle's overall appeal and technological sophistication.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The term “about” is intended to include the degree of error associated with measurement of the particular quantity based upon the equipment available at the time of filing the application. For example, “about” can include a range of ±8% of a given value.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A steering assembly of a vehicle, comprising:
a housing configured for operable connection to a steering column of the vehicle; and
one or more steering handles disposed at the housing, the one or more steering handles rotatably mounted to the housing to rotate about respective steering handle axes relative to the housing between an extended position and a folded position.

2. The steering assembly of claim 1, wherein the one or more steering handles is two steering handles disposed at opposing lateral sides of the housing, the steering assembly further comprising two spur gears, each steering handle of the two steering handles is operably connected to a respective spur gear of the two spur gears, the two spur gears meshed with each other inside the housing;
wherein rotation of the two spur gears rotates the two steering handles about their respective steering handle axes.

3. The steering assembly of claim 2, further comprising a motor operably connected to at least one spur gear of the two spur gears to drive rotation of the two spur gears.

4. The steering assembly of claim 1, further comprising a housing opening in the housing to receive a steering column of the vehicle, the steering assembly configured to rotate about a steering column axis together with the steering column.

5. The steering assembly of claim 4, wherein the steering assembly is configured to selectably translate along the steering column axis relative to the steering column.

6. The steering assembly of claim 4, further comprising one or more alignment grooves in the housing opening to rotationally align the steering assembly with the steering column.

7. The steering handle assembly of claim 1, further comprising an air bag module disposed in the housing.

8. A steering system of a vehicle comprising:
a steering column; and
a steering assembly operably connected to and rotatable about a steering column axis with the steering column, the steering assembly including:
a housing configured for operable connection to the steering column; and
two steering handles disposed at opposing lateral sides of the housing, the two steering handles rotatably mounted to the housing to rotate about respective steering handle axes relative to the housing between an extended position and a folded position.

9. The steering system of claim 8, further comprising two spur gears, each steering handle of the two steering handles operably connected to a respective spur gear of the two spur gears, the two spur gears meshed with each other inside the housing;
wherein rotation of the two spur gears rotates the two steering handles about their respective steering handle axes.

10. The steering system of claim 9, further comprising a motor operably connected to at least one spur gear of the two spur gears to drive rotation of the two spur gears.

11. The steering system of claim 8, further comprising a housing opening in the housing to receive the steering column.

12. The steering system of claim 11, wherein the steering assembly is configured to selectably translate along the steering column axis relative to the steering column.

13. The steering system of claim 11, further comprising one or more alignment grooves in the housing opening to rotationally align the steering assembly with the steering column.

14. The steering system of claim 8, further comprising an air bag module disposed in the housing.

15. A vehicle comprising:
a vehicle body defining a passenger compartment;
a steering system of the vehicle disposed in the passenger compartment, the steering system including:
a steering column; and
a steering assembly operably connected to a rotatable about a steering column axis with the steering column, the steering assembly including:
a housing configured for operable connection to the steering column; and
two steering handles disposed at opposing lateral sides of the housing, the two steering handles rotatably mounted to the housing to rotate about respective steering handle axes relative to the housing between an extended position and a folded position.

16. The vehicle of claim 15, further comprising two spur gears, each steering handle of the two steering handles operably connected to a respective spur gear of the two spur gears, the two spur gears meshed with each other inside the housing;
wherein rotation of the two spur gears rotates the two steering handles about their respective steering handle axes.

17. The vehicle of claim 15, further comprising a housing opening in the housing to receive the steering column.

18. The vehicle of claim 17, wherein the steering assembly is configured to selectably translate along the steering column axis relative to the steering column.

19. The vehicle of claim 17, further comprising one or more alignment grooves in the housing opening to rotationally align the steering assembly with the steering column.

20. The vehicle of claim 18, further comprising an instrument panel disposed in the passenger compartment, the steering column extending from a steering opening in the instrument panel;
wherein the steering handle is selectably translatable at least partially into the steering opening.
